(19) United States
(12) Patent Application Publication
(10) Pub. No.: US 2005/0268035 A1
(43) Pub. Date: Dec. 1, 2005

(54) RAID controller module

(75) Inventors: Yuan-Lung Chang, Taipei City (TW); Yuan-Huei Chang, Taipei City (TW)

Correspondence Address: MCNEES, WALLACE & NURICK LLC, 100 PINE STREET, P.O. BOX 1166, HARRISBURG, PA, 17108-1166, US

(73) Assignee: eTrunk Technologies Inc., Taipei City (TW)

(21) Appl. No.: 10/968,447

(22) Filed: Oct. 19, 2004

(30) Foreign Application Priority Data
May 31, 2004 (TW) 093208544

(51) Int. Cl. G06F 12/00

(52) U.S. Cl. 711/114; 711/168

(57) ABSTRACT

A controller module is adapted for connecting a main board to a RAID device that includes a set of data storage media, and includes a control unit mounted on a circuit board. A first interface unit is mounted on the circuit board, and is connected electrically to the control unit. Each first ribbon cable in a set thereof has a first end coupled electrically to the first interface unit, and a second end opposite to the first end and adapted to be coupled electrically to a respective one of the data storage media of the RAID device. A second interface unit is mounted on the circuit board, is connected electrically to the control unit, and is adapted to be coupled electrically to the main board. The control unit is adapted to enable the main board to access simultaneously each of the data storage media of the RAID device.

### CROSS-REFERENCE TO RELATED APPLICATION

This application claims priority of Taiwanese Application No. 093208544, filed on May 31, 2004.

### BACKGROUND OF THE INVENTION

1. Field of the Invention

The invention relates to a controller module, more particularly to a RAID controller module.

2. Description of the Related Art

In recent years, data processing speeds for CPUs have been greatly increased. Memory data access speeds have also been enormously increased. This is in contrast to data access speeds for data storage media, such as hard disks, which have experienced very minimal increases (i.e., by a factor of three or four).

In order to improve data access speeds for hard disks, there have been proposed two techniques: a disk cache control technique, and a redundant arrays of independent disks (RAID) technique.

FIG. 1 illustrates a conventional RAID controller 10 for connecting a main board 50′ and a RAID device 1 that includes a set of hard disks 11, 12, 13, 14. The conventional RAID controller 10 includes a circuit board 100 having one edge formed with a set of board edge contacts, such as gold fingers (not shown), that are plugged into a slot 51′, such as an IDE slot or a PCI slot, on the main board 50′ so as to permit direct electrical connection with the main board 50′; a set of control units 101, 102, 103, 104 mounted on the circuit board 100; a set of interface units 201, 202, 203, 204, such as IDE interfaces, connected electrically and respectively to the control units 101, 102, 103, 104; and a set of ribbon cables 21, 22, 23, 24, each of which has a first end connected electrically to a respective one of the interface units 201, 202, 203, 204, and a second end opposite to the first end and connected electrically to a respective one of the hard disks 11, 12, 13, 14.

In such a configuration, due to the presence of the gold fingers and the interface units 201, 202, 203, 204, the circuit board 10 needs to be relatively large. Furthermore, the gold fingers, which are used to connect electrically the circuit board 100 to the main board 50′, have fixed specifications which may not be compatible for use with other main boards.

### SUMMARY OF THE INVENTION

Therefore, the object of the present invention is to provide a RAID controller module that is relatively small and that is suitable for application to different interface specifications.

According to the present invention, there is provided a controller module for connecting a main board to a RAID device that includes a set of data storage media. The controller module comprises:
a circuit board;
a control unit mounted on the circuit board;
a first interface unit mounted on the circuit board and connected electrically to the control unit;
a set of first ribbon cables, each of which has a first end coupled electrically to the first interface unit, and a second end opposite to the first end and adapted to be coupled electrically to a respective one of the data storage media of the RAID device; and
a second interface unit mounted on the circuit board, connected electrically to the control unit, and adapted to be coupled electrically to the main board,
wherein the control unit is adapted to enable the main board to access simultaneously each of the data storage media of the RAID device.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing a conventional RAID controller in a state of use;

FIG. 2 is a schematic top view showing the preferred embodiment of a controller module according to this invention;

FIG. 3 is a schematic side view showing the preferred embodiment;

FIG. 4 is perspective view showing the preferred embodiment in a state of use; and

FIG. 5 is a schematic circuit block diagram illustrating the preferred embodiment.

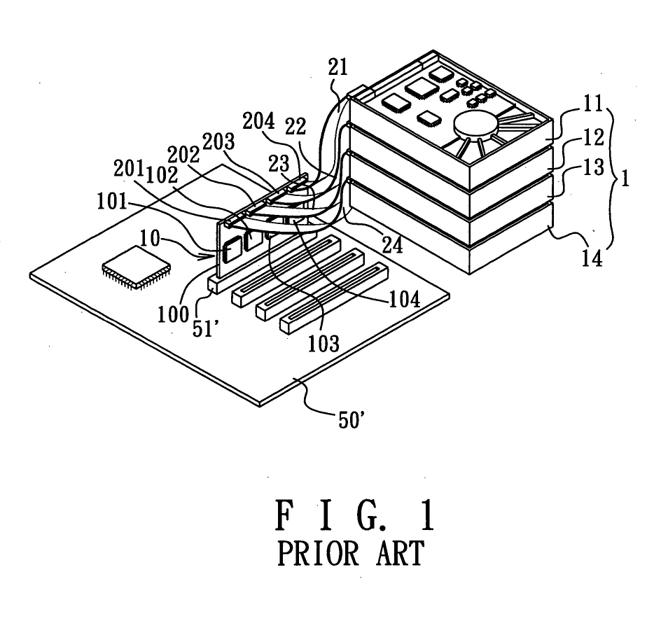

### DETAILED DESCRIPTION OF THE PREFERRED EMBODIMENT

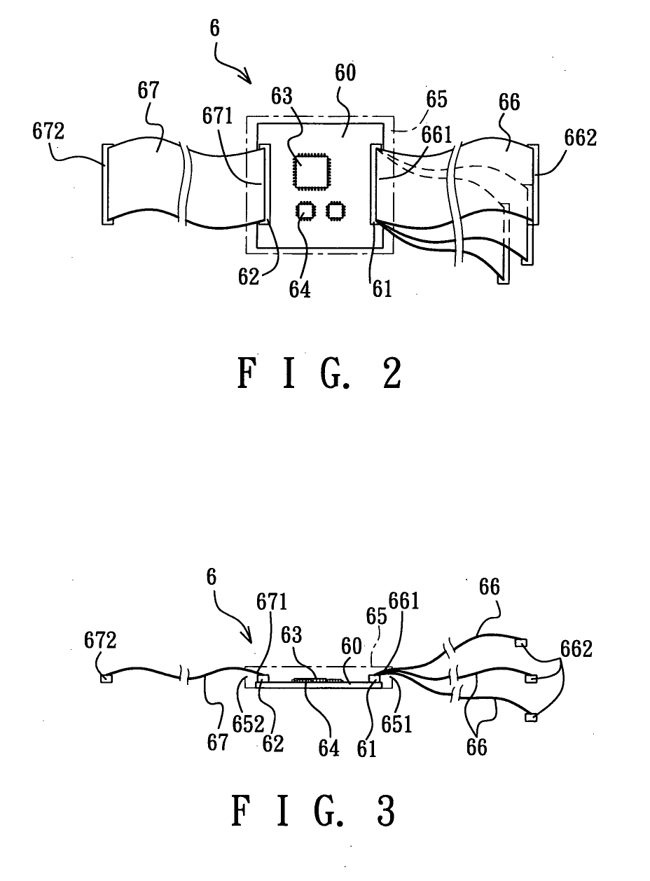

Referring to FIGS. 2 to 4, the preferred embodiment of a controller module 6 according to the present invention is adapted for connecting a main board 50 to a RAID device 4 that includes a set of data storage media 41, 42, 43, such as hard disks. In this embodiment, the main board 50 is provided with a CPU 51 and a plurality of slots 52, such as IDE slots, PCI slots or SCSI slots, thereon. The controller module 6 includes a circuit board 60, a control unit 63, a first interface unit 61, a set of first ribbon cables 66, a second interface unit 62, and a second ribbon cable 67.

The control unit 63 is mounted on the circuit board 60.

The first interface unit 61 is mounted on the circuit board 60, and is connected electrically to the control unit 63. In this embodiment, the first interface unit 61 can be one of an IDE interface and an SCSI interface.

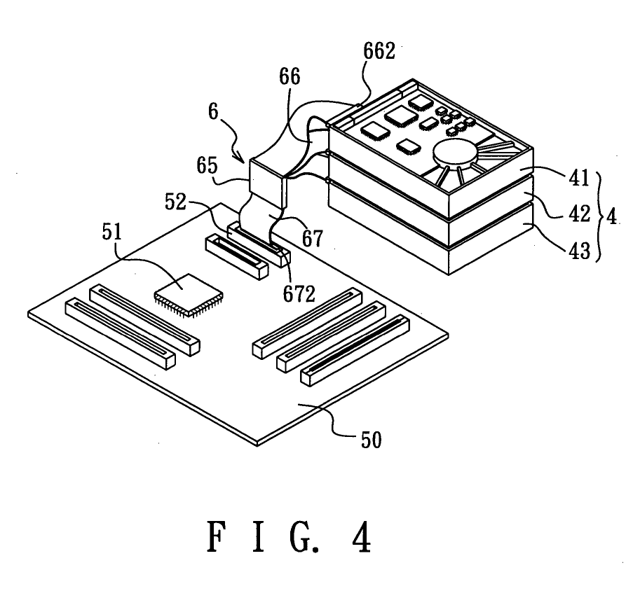

Each of the first ribbon cables 66 has a first end 661 coupled electrically to the first interface unit 61, and a second end 662 opposite to the first end 661 and adapted to be coupled electrically to a respective one of the data storage media 41, 42, 43 of the RAID device 4 via a connector unit corresponding to the first interface unit 61, as shown in FIG. 4.

The second interface unit 62 is mounted on the circuit board 60, and is connected electrically to the control unit 63. In this embodiment, the second interface unit 62 can be an IDE interface, a PCI interface and an SCSI interface.

The second ribbon cable 67 has opposite ends 671, 672, wherein the end 671 of the second ribbon cable 67 is coupled electrically to the second interface unit 62, and the end 672 is adapted to be coupled electrically to one of the slots 52 on the main board 50 via a connector corresponding to the slot 52, as shown in FIG. 4.

The controller module 6 further includes a housing 65 for accommodating the circuit board 60, the control unit 63, and the first and second interface units 61, 62 therein. The housing 65 is formed with a first opening 651 for permitting the first ribbon cables 66 to extend outwardly of the housing 65 therethrough, and a second opening 652 for permitting the second ribbon cable 67 to extend outwardly of the housing 65 therethrough, as best shown in FIG. 3.

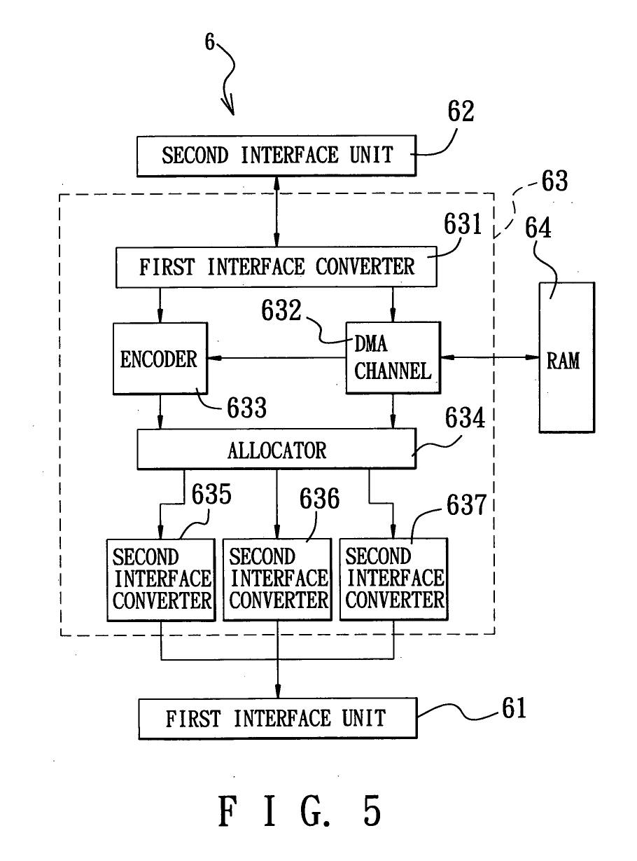

The control unit 63 is adapted to enable the main board 50 to access simultaneously each of the data storage media 41, 42, 43 of the RAID device 4. In this embodiment, as shown in FIG. 5, the control unit 63 includes a first interface converter 631 coupled electrically to the second interface unit 62, a direct memory access (DMA) channel 632 connected electrically to both the first interface converter 631 and a RAM 64 mounted on the circuit board 60, an encoder 633 connected electrically to the first interface converter 631 and the DMA channel 632, an allocator 634 connected electrically the encoder 633 and the DMA channel 632, and a plurality of second interface converters 635, 636, 637, each of which is connected electrically to the allocator 634 and the first interface unit 61.

As an example of the operation of the control unit 63, in a data storage procedure, data from the main board 50 is converted into a desired format by the first interface converter 631, and the data in the desired format is stored in the RAM 64 via the DMA channel 632. The encoder 633 generates encoded storage addresses for the data stored in the RAM 64. The allocator 634 allocates the data stored in the RAM 64 to the data storage media 41, 42, 43, upon conversion by the second interface converters 635, 636, 637, via the first interface unit 61. In this embodiment, the data storage media 41, 42 serve as main data storage areas, and the data storage medium 43 serves as a data backup area.

Due to the presence of the first and second interface units 61, 62, and the first and second ribbon cables 66, 67, the size of the circuit board 60 can be decreased. Furthermore, the controller module of this invention may be made suitable for RAID devices having different interface specifications, and main boards provided with different slot specifications by selecting the first and second ribbon cables 66, 67 with appropriate specifications.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A controller module for connecting a main board to a RAID device that includes a set of data storage media, said controller module comprising:
a circuit board;
a control unit mounted on said circuit board;
a first interface unit mounted on said circuit board and connected electrically to said control unit;
a set of first ribbon cables, each of which has a first end coupled electrically to said first interface unit, and a second end opposite to said first end and adapted to be coupled electrically to a respective one of the data storage media of the RAID device; and
a second interface unit mounted on said circuit board, connected electrically to said control unit, and adapted to be coupled electrically to the main board,
wherein said control unit is adapted to enable the main board to access simultaneously each of the data storage media of the RAID device.

2. The controller module as claimed in claim 1, wherein said first interface unit is one of an IDE interface and an SCSI interface.

3. The controller module as claimed in claim 1, wherein said second interface unit is one of an IDE interface, a PCI interface and a SCSI interface.

4. The controller module as claimed in claim 1, further comprising a second ribbon cable having opposite ends, one of which is coupled electrically to said second interface unit, and the other one of which is adapted to be coupled electrically to the main board.

5. The controller module as claimed in claim 4, further comprising a housing for accommodating said circuit board, said control unit, and said first and second interface units therein, said housing being formed with a first opening for permitting said first ribbon cables to extend outwardly of said housing therethrough, and a second opening for permitting said second ribbon cable to extend outwardly of said housing therethrough.
